(19) United States
(12) Patent Application Publication
(10) Pub. No.: US 2019/0031397 A1
(43) Pub. Date: Jan. 31, 2019

(54) COMBINATION FOOD CUP AND DIPPING TRAY

(71) Applicant: James E. Grove, Marina Del Rey, CA (US)

(72) Inventor: James E. Grove, Marina Del Rey, CA (US)

(21) Appl. No.: 15/659,537

(22) Filed: Jul. 25, 2017

(51) Int. Cl. B65D 21/02; B65D 1/36; B65D 77/04; B65D 81/32; B60N 3/10; B60R 11/00

(52) U.S. Cl. CPC B65D 21/0237; B65D 1/36; B65D 77/0426; B65D 2207/00; B60N 3/10; B60R 11/00; B65D 81/3216

(57) ABSTRACT

Disclosed herein is a combination food cup to carry a snack food, such as vegetables, and a dipping tray having a plurality of dip compartments recessed therein to carry dips or sauces to enhance the food prior to its consumption. The food cup is ideally carried by a cup holder at the center console found in many motor vehicles. The dipping tray is attached to the cup so as to extend around the top thereof above the cup holder in which the cup is located. The tray can be fixedly attached to the cup to establish a one-piece combination or detachably connected in surrounding engagement with the cup to establish a two-piece combination. In this case, a set of threads which extends around the cup is rotated into mating engagement with a set of threads which extends around a cup receiving and docking port that runs axially through the center of the tray.

### BACKGROUND OF THE INVENTION

### 1. Field of the Invention

This invention relates to a combination food cup and dipping tray that has particular application to be transported in a motor vehicle and held in place by the cup holder of the usual center console that is found in most vehicles. The cup of the combination is preferably filled with a solid food (e.g., chips, carrots or celery sticks) that is suitable for dipping, and the dipping tray is attached to and surrounds the top of the cup to be filled with a complementary dip or sauce into which the food can be dipped prior to its consumption.

### 2. Background Art

Occasionally one who drives a motor vehicle for a long period of time becomes hungry and longs for a food snack to eat along the journey. At the same time, it may also be appealing for the driver to have ready access to a dip or sauce to be mixed with the food to enhance the taste thereof prior to its consumption. In this regard, it is preferable that any such food be stored in a compact covered container that is convenient to transport in the motor vehicle so as to be capable of being held in place within the vehicle while remaining at all times within easy reach of the driver without the driver having to spend time to search for the food. Likewise, it would also be preferable for the dip or sauce to be stored in a covered dip container that is attached in close proximity to the food container so that the food and dipping containers can be transported together as a unit and thereby avoid their becoming accidentally separated and one or the other being misplaced. No such compact combination food and dipping container assembly is known to the applicant herein which has particular application to be transported in a motor vehicle and held in place by the cup holder of the usual center console thereof so that both the food and the dip can be easily accessed and consumed by the driver while the vehicle is standing still.

### SUMMARY OF THE INVENTION

In general terms, a combination food cup and dipping tray is disclosed that has particular application for being transported in a motor vehicle to enable the vehicle operator or his passenger to have access to a consumable solid food snack (e.g., vegetables or chips) that is carried by the cup and a dip or sauce that is carried in the dipping tray to enhance the taste of the food. The food cup and dipping tray are preferably manufactured from an optically transparent material that is capable of withstanding a conventional high pressure processing (HPP) treatment that is performed to increase the refrigerated shelf life of the foods being carried by the cup and the tray. The dipping tray is located in surrounding engagement with the top of the food cup to lie above the usual center console of the motor vehicle when the cup is received within and held in place by the cup holder thereof. A series of dip compartments in which dips or sauces are carried extend end-to-end one another around the dipping tray. A peel-off film closure is sealed over and across the food cup and the tipping tray, and a lid is removably attached to the dipping tray to cover the peel-off film closure.

According to a first preferred embodiment, the food cup and the dipping tray are integrally connected to another to create a one-piece combination. According to a second preferred embodiment, the food cup and the dipping tray are detachably connected to one another to create a two-piece combination. In this case, a cup receiving and docking port runs through the center of the dipping tray for receipt therewithin of the food cup. A first set of threads formed on the food cup is rotated into mating engagement with an opposing set of threads formed on the cup receiving and docking port by which the cup and the tray are detachably connected together.

### BRIEF DESCRIPTION OF THE DRAWINGS

FIG. 1 is an exploded perspective view showing a first preferred embodiment for a one-piece combination food cup and dipping tray;

FIG. 2 is a cross-section of the top of the combination shown in FIG. 1 with the dipping tray affixed to the food cup in surrounding engagement therewith;

FIG. 3 is a cross-section of the combination shown in FIG. 1 with the food cup thereof received within the cup holder of the center console of a motor vehicle and including a peel-off film closure being removed from across the top of the combination;

FIG. 4 is an exploded cross-section showing a second preferred embodiment for a two-piece combination food cup and dipping tray; and

FIG. 5 shows the combination of FIG. 4 with the dipping tray detachably connected to the food cup in surrounding engagement therewith.

### DESCRIPTION OF THE PREFERRED EMBODIMENT

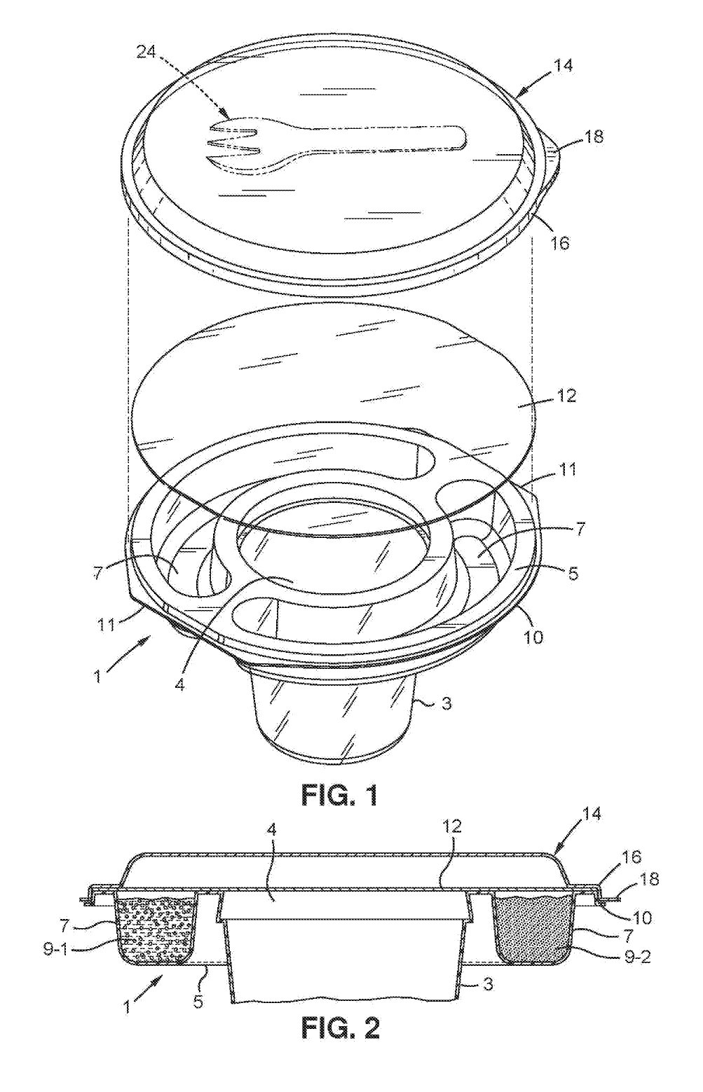

Referring initially to FIGS. 1-3 of the drawings, there is shown a first embodiment for a combination food cup and dipping tray. In the case of FIGS. 1-3, a one-piece combination 1 is shown including a food cup 3 integrally connected to a dipping tray 5. By way of example only, the combination 1 has particular application for being transported and used in a motor vehicle to enable the vehicle operator or his passenger to have quick and convenient access to a consumable food snack while on the go and without their having to spend time to search for the snack. However, the combination 1 may be used elsewhere such as, for example, while an individual is at home sitting in a chair of the kind having a drink holder which is sized to receive therewithin and hold a beverage container or a cup. Thus, it is to be understood that the location at which the combination 1 is used can vary from one place to another.

The food cup 3 of the combination 1 is preferably manufactured from an optically transparent material (e.g., plastic) that is capable of withstanding a conventional high pressure processing (HPP) treatment to which the food contents of the cup 3 are exposed to eliminate potentially harmful food-borne pathogens and similar organisms in order to extend the refrigerated shelf life of the contents. By way of example, the cup 3 can be filled with a vegetable, such as carrots or celery sticks or any other solid food that is suitable to be grasped and dipped.

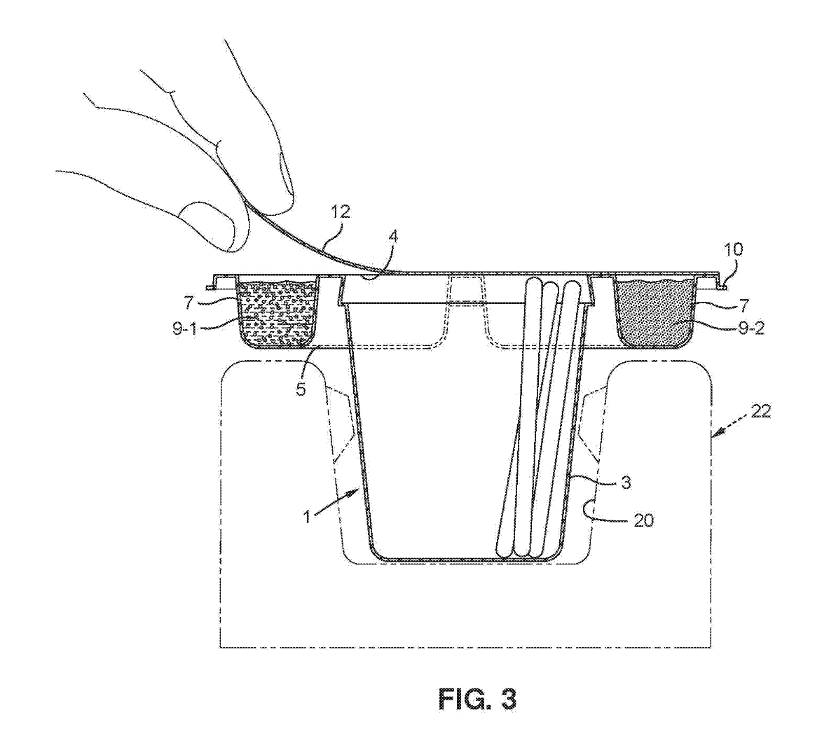

The food cup 3 has a generally cylindrical configuration with dimensions that are tailored so that the cup can be received by and supported within a standard cup, can or bottle holder (designated 20 in FIG. 3) of the kind that is typically found in the center console 22 of a motor vehicle. The cup 3 is sufficiently tall to stand above the console 22 and be able to carry any of a variety of solid dippable foods such as those listed above. The food cup 3 has an open top 4 through which the food contents carried by the cup can be grasped and removed.

The dipping tray 5 of the combination 1 is affixed in coextensive surrounding engagement to the food cup 3. As is best shown in FIG. 3, the dipping tray 5 is ideally located around the open top 4 of the cup 3 so as to lie above the vehicle console 22 when the cup is located within the cup holder 20 thereof. The dipping tray 5 is also preferably manufactured from an optically transparent material (e.g., plastic) that is capable of withstanding the aforementioned HPP treatment after it has first been filled with a dip, sauce or the like that is complementary to the food carried inside the cup 3. However, it is to be understood that the contents of the cup 3 and the dipping tray 5 of the combination 1 are optional and form no part of the present invention.

The dipping tray 5 of the combination 1 has a number of dip compartments 7 formed therein to be filled with any of a variety of dips or sauces to enhance the taste of the food contents of the cup 3. While two dip compartments 7 are illustrated in FIG. 1, the actual number and length of the dip compartments that are formed in the dipping tray 5 are a matter of choice depending upon the food carried by the cup 3. The tipping tray 5 that is shown surrounding the top of cup 3 has, for example, a ring-like configuration. Therefore, the dip compartments 7 which encircle the cup 3 have a corresponding arcuate configuration so as to be aligned end-to-end one another around the cup.

As is best shown in FIG. 2, the dip compartments 7 of the ring-shaped dipping tray 5 that surrounds the food cup 3 have a depth which extends below the open top 4 of the cup. A relatively thin peripheral locking lip 10 surrounds the dipping tray 5 and projects radially outwardly therefrom. As is best shown in FIG. 1, the peripheral locking lip 10 which surrounds the dipping tray 5 has a flat 11 located at opposite sides thereof. The flats 11 allow the combination food cup 3 and dipping tray 5 to be laid and retained on its side for the purpose of being able to more clearly display the contents thereof to purchasers through the optically transparent material from which the combination is manufactured.

The combination cup and dipping tray is covered by an optically transparent, peel-off film closure 12 which is sealed across the open top 4 of the cup 3 and the open dip compartments 7 of the dipping tray 5 in order to prevent their contents from falling out. As is best shown in FIG. 3, an individual can grasp the peel-off film closure 12 and apply an upward pulling force thereto by which to remove the closure and enable the individual to open the combination 1 in order to gain access to the contents of the cup 3 and the dipping tray 5. That is, the individual can use his fingers to reach into the cup 3, remove some of the food contents therefrom, dip the food into one or more of the dip compartments 7, and then consume the food that has been removed from the cup 3 and enhanced by a dip or sauce from the dip compartments 7.

A lid 14 is removably attached over the food cup 3 and the dipping tray 5 of the combination 1 to cover the film closure 12. The lid 14 is preferably manufactured from an optically transparent (e.g., plastic) material that is capable of withstanding the aforementioned HPP treatment. The lid 14 has a peripheral rim 16 that is sized to surround and frictionally, engage the dipping tray 5 at the peripheral locking lip 10 thereof (best shown in FIG. 2). Because the dipping tray 5 is shown having a ring-like shape, the lid 14 which surrounds the dipping tray has a corresponding circular peripheral rim 16.

The lid 14 of the combination 1 has an integral pull tab 18 projecting outwardly from one side thereof. When it is desirable to consume the contents of the food cup 3, the pull tab 18 is pulled up and the lid 14 is removed from its surrounding engagement with the dipping tray 5. The film closure 12 is then grasped and separated from the combination 1 as previously, described. When the contents of the food cup 3 are either partially or completely consumed, the lid 14 may be returned to its surrounding engagement with the dipping tray 5 by pushing the rim 16 of the lid 14 downwardly against the peripheral locking lip 10 of dipping tray 5.

An optional disposable fork (shown in phantom lines and designated 24 in FIG. 1) is shown being carried at the bottom of the lid 14. The fork 24 can be frictionally retained within a recess (not shown) that is formed in the lid 14. If necessary, and once the lid 14 has been removed, the fork 24 can be separated from the lid and used to grasp and move the food from the food cup 3 to the dipping tray 5 prior to consumption.

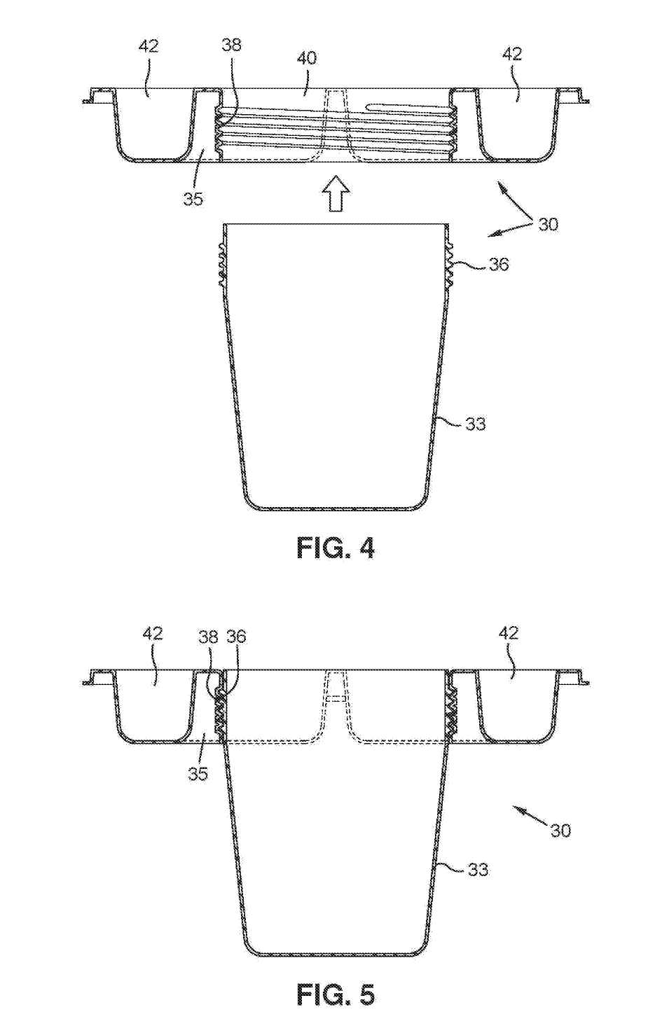

A second embodiment for a combination food cup and dipping tray is now described while referring to FIGS. 4 and 5 of the drawings. While a one-piece combination 1 is shown in FIGS. 1-3, where a food cup 3 is integrally and coextensively connected to a dipping tray 5, a two-piece combination 30 is shown in FIGS. 4 and 5, where a food cup 33 is detachably connected to a dipping tray 35. The food cup 33 of the combination 30 will ideally have a size that is similar to the size of the cup 3 so that the cup 30 can be received and held in place by the cup holder 20 of the usual center console 22 of a motor vehicle as shown in FIG. 3 so as to be readily accessible to a driver or a passenger without their having to search the vehicle.

Unlike the cup 3 of the combination 1, the food cup 33 of the combination 30 has a plurality of threads 36 formed in and extending therearound. In the example shown in FIG. 4, the threads 36 extend continuously around the outside of the cup 33 at top thereof. However, the threads 36 around the outside of the cup 33 may also be a set of half threads (not shown) to facilitate a quick detachable connection of the cup 33 to the dipping tray 35 in a manner that will soon be explained.

The dipping tray 35 has a set of complementary threads 38 that extend around a cylindrical open-ended cup receiving and docking port 40. The port 40 runs axially through the center of tray 35 and is surrounded by dip compartments 42. The threads 38 of the dipping tray 35 are formed around the cup receiving and docking port 40 so as to be mated to the threads 36 of the food cup 33 when the cup 33 is detachably connected to tray 35.

As is shown in FIG. 4, the food cup 33 is detachably connected to the dipping tray 35 to complete the two-piece combination 30. The foregoing detachable connection is achieved when the cup 33 is moved upwardly towards the dipping tray 35 and rotated in a first direction within the cylindrical open-ended cup receiving and docking port 40 at the center thereof. Accordingly, the threads 36 which run around the outside of the food cup 33 are rotated into mating engagement with the threads 38 that run around the cup receiving and docking port 40. With the food cup 33 detachably connected to dipping tray 35 as shown in FIG. 5, the bottom of the cup will depend downwardly from the tray to be received within and held in place by the cup holder 20 of the console 22 of FIG. 3.

The food cup 33 is rotated in an opposite direction to be detached from the cup receiving and docking port 40 of the dipping tray 35. By virtue of being able to separate the cup 33 from the tray 35, the combination 30 may be manufactured and shipped disassembled to conserve space. Moreover, once the food and dip have been consumed, the dipping tray 35 may be discarded while the cup 33 can be washed and reused to hold water or the like.

1.-19. (canceled)

20. A cup and tray combination comprising:
a cup holder having a top and a bottom;
a cup having a round top and a round bottom, said cup being received within said cup holder such that the round top of said cup stands above the top of said cup holder and the round bottom of said cup lies below the top of said cup holder; and
a tray attached to said cup at the round top thereof, said tray having a plurality of food compartments that lie end-to-end one another and completely encircle the round top of said cup, said plurality of food compartments being recessed within and extending downwardly from said tray so as to lie over and above the top of said cup holder and thereby retain the round top of said cup above the top of said cup holder.

21. The combination cup and tray recited in claim 20, wherein said cup holder is located at the center console of a motor vehicle.

22. The combination cup and tray recited in claim 20, further comprising a first food located within said cup and one or more additional foods located in respective ones of the plurality of food compartments of said tray.

23. The combination cup and tray recited in claim 20, wherein said tray is detachably connected to said cup, and wherein said tray has a center, a cup receiving and docking port running axially through said center, and a first set of threads surrounded by the plurality of food compartments of said tray, and
said cup having a second set of threads located around the round top thereof, said cup being located within the cup receiving and docking port of said tray so that said second set of threads is located opposite and surrounded by said first set of threads,
said cup being rotatable relative to said tray when said cup is located within the cup receiving and docking port of said tray so that said first and second sets of threads are correspondingly rotated into releasable mating engagement with one another and said tray is thereby detachably connected to said cup.

24. A combination cup and tray comprising:
a cup holder having a top and a bottom;
a cup having a top and a bottom, said cup being received within said cup holder such that the top of said cup stands above the top of said cup holder and the bottom of said cup lies below the top of said cup holder; and
a tray detachably connected to said cup at the top thereof, said tray having at least one food compartment being recessed within and extending downwardly from said tray so as to lie over and above the top of said cup holder, whereby to retain the top of said cup above the top of said cup holder, said tray also having a center, a cup receiving and docking port running axially through said center; and a first set of threads surrounded by the at least one food compartment of said tray; and
said cup having a second set of threads located at the top thereof, said cup being located within the cup receiving and docking port of said tray so that said second set of threads is located opposite said first set of threads, and said cup being rotatable relative to said tray when said cup is located within the cup receiving and docking port of said tray to that said first and second sets of threads are correspondingly rotated into releasable mating engagement with one another and said tray is thereby detachably connected to said cup such that the top of said cup and the second set of threads thereof do not extend above said tray and the at least one food compartment recessed within said tray.

25. The combination cup and tray recited in claim 24, wherein said tray has a ring shape so as to be detachably connected in surrounding engagement to the top of said cup.

26. The combination cup and tray recited in claim 24, further comprising a peel-off film that is removably attached over and across each of the top of said cup and the at least one food compartment of said tray.

27. The combination cup and tray recited in claim 26, further comprising a lid detachably connected to said tray so as to lie over and cover said peel-off film.

28. The combination cup and tray recited in claim 27, wherein said lid is detachably connected to said tray at a peripheral locking lip that surrounds said tray, said peripheral locking lip having a flat side that lays upon said tray.

29. The combination cup and tray recited in claim 27, further comprising an eating utensil removably attached to said lid.

30. The combination cup and tray recited in claim 24, further comprising a first food located within said cup and a second food located within the at least one food compartment of said tray.
